(19) United States
(12) Patent Application Publication
(10) Pub. No.: US 2023/0006472 A1
(43) Pub. Date: Jan. 5, 2023

(54) WIRELESS CHARGING PAD

(71) Applicant: HADES-GAMING CORP., New Taipei City (TW)

(72) Inventors: Ho Lung LU, New Taipei City (TW); Chin-Lung LIN, New Taipei City (TW)

(73) Assignee: HADES-GAMING CORP., New Taipei City (TW)

(21) Appl. No.: 17/500,232

(22) Filed: Oct. 13, 2021

(30) Foreign Application Priority Data
Jun. 30, 2021 (TW) 110124080

(51) Int. Cl. H02J 50/10; H01F 38/14

(52) U.S. Cl. CPC H02J 50/10; H01F 38/14; H02J 50/402

(57) ABSTRACT

A wireless charging pad includes a mat part and a coil. The mat part includes a first and second layer. The first layer has contact surface and recess formed on the contact surface. The recess has a slot area and a coil accommodation area connected to each other. The coil is located within the coil accommodation area. The accommodation area is located at a side of the slot area away from the contact surface. The second layer is stacked on the contact surface to cover the recess. The slot area has a first opening at the contact surface, the first opening has a first width of W1, the slot area has a second opening connected to the coil accommodation area, the second opening has a second width of W2, the coil accommodation area has a third width of W3. The following conditions are satisfied: W1≥W2; and W3>W2.

### CROSS-REFERENCE TO RELATED APPLICATIONS

This non-provisional application claims priority under 35 U.S.C. § 119(a) on Patent Application No(s). 110124080 filed in Taiwan, R.O.C. on Jun. 30, 2021, the entire contents of which are hereby incorporated by reference.

### TECHNICAL FIELD

The disclosure relates to a wireless charging pad.

### BACKGROUND

In recent years, various mouse pads featuring wireless charging functions are available in the market. The coil integrated in the mouse pad can charge the mouse or other electronic device placed thereon. In a typical wireless charging mouse pad, the charging coil is embedded into the groove formed on one of the layers of the mouse pad and then is covered by adhesive to be fixed in position. However, the adhesive increases cost and makes the manufacturing process complex.

### SUMMARY

One embodiment of the disclosure provides a wireless charging pad including a mat part and a coil. The mat part includes a first layer and a second layer. The first layer has a contact surface and a recess formed on the contact surface. The recess has a slot area and a coil accommodation area connected to each other. The coil is located within the coil accommodation area. The accommodation area is located at a side of the slot area away from the contact surface. The second layer is stacked on the contact surface to cover the recess. The slot area has a first opening at the contact surface, the first opening has a first width of W1, the slot area has a second opening connected to the coil accommodation area, the second opening has a second width of W2, the coil accommodation area has a third width of W3. The following conditions are satisfied: W1≥W2; and W3>W2.

### BRIEF DESCRIPTION OF THE DRAWINGS

The present disclosure will become better understood from the detailed description given hereinbelow and the accompanying drawings which are given by way of illustration only and thus are not intending to limit the present disclosure and wherein:

FIG. 1 is a planar view of a wireless charging pad according to one embodiment of the disclosure;

FIG. 2 is a partially enlarged cross-sectional view of the wireless charging pad taken along line 2-2 in FIG. 1;

FIG. 3 is an exploded view of the wireless charging pad in FIG. 2;

FIG. 4 is a partially enlarged cross-sectional view of the first layer in FIG. 2;

FIG. 5 is a partially enlarged cross-sectional view of a first layer according to another embodiment of the disclosure; and

FIG. 6 is a partially enlarged cross-sectional view of a first layer according to yet another embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

The following embodiments will be described with reference to the drawings. For the purpose of clear illustration, some conventional elements may be depicted in a simplified manner or omitted from the drawings. Also, for the same reason, one or more elements may be depicted in dotted lines. In addition, the same reference number may denote the same element or component.

Further, terms, such as “substantially” and “approximately”, as used herein, relate to an industry-accepted tolerance to the corresponding term. The term “at least one” used herein may mean that the quantity of the described element is one or more than one but does not necessarily mean that the quantity is only one, unless otherwise specified. The term “and/or” may be used herein to indicate either or both of two stated possibilities. In the expression that an element is “connected”, “coupled” or adhered” to another element, there may be one or more intervening elements arranged therebetween, unless otherwise specified.

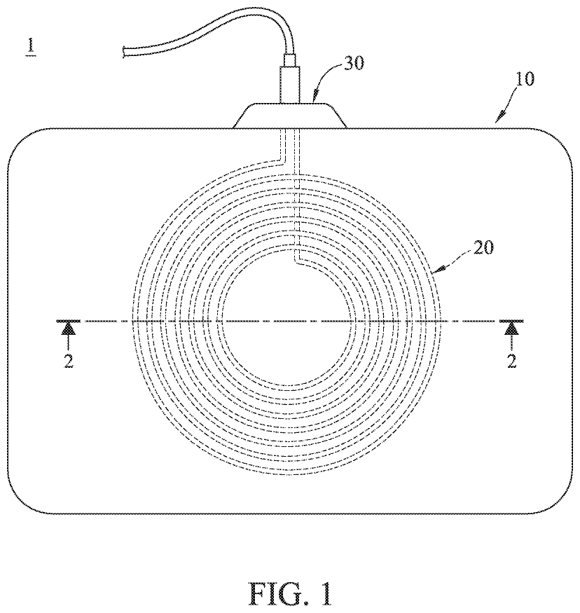

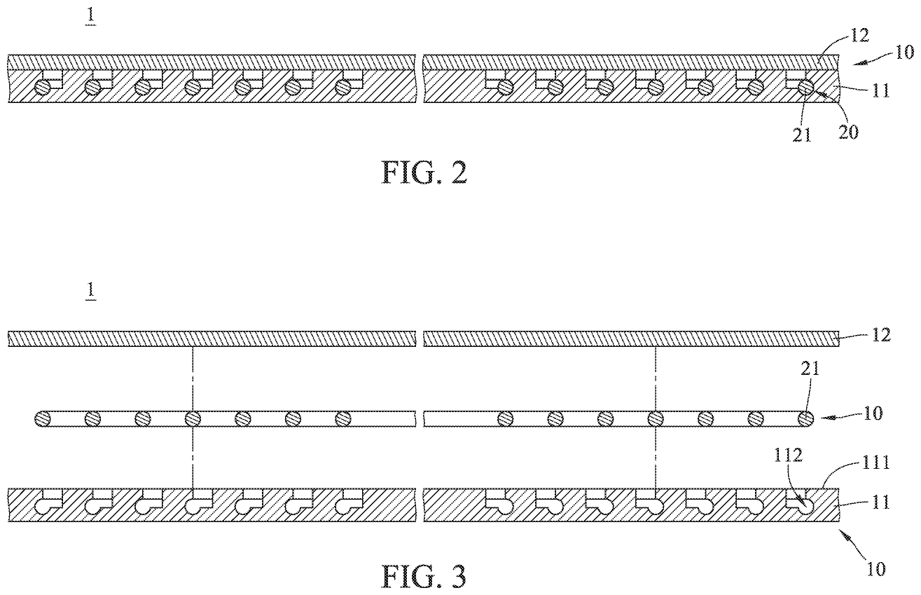

Firstly, referring to FIGS. 1-3, one embodiment of the disclosure provides a wireless charging pad 1, the wireless charging pad 1 may generally include a mat part 10 and a coil layer 20. The mat part 10 may be in any suitable shape and size and is able to accommodate the coil layer 20. A connection module 30 is electrically connected between the coil layer 20 and an external power source, such that the coil layer 20 can receive electricity via the connection module 30.

In this embodiment, the mat part 10 may at least include a first layer 11 and a second layer 12. The first layer 11 may be made of any suitable soft and flexible material, such as silicone or rubber. The second layer 12 may be made of any material suitable for providing a surface for moving a mouse, such as Mylar, polyester, rubber, paper, or glass.

The second layer 12 is stacked on the first layer 11. The first layer 11 has a contact surface 111 used to be attached to the second layer 12. The contact surface 111 may be adhered to the second layer 12 by using adhesive or any suitable means. The coil layer 20 includes one or more coils 21 embedded in a recess 112 at the contact surface 111. The coil 21 is a typical charging coil that may be in any suitable material, size, and shape. The coil 21 is arranged along the recess 112 so that the coil layer 20 forms a pattern as shown in FIG. 1.

As shown, the coil 21 is arranged between the first layer 11 and the second layer 12 so as to be embedded within the mat part 10. Note that the configuration of the recess 112 secures the position of the coil 21 without additionally providing adhesive for fixing it.

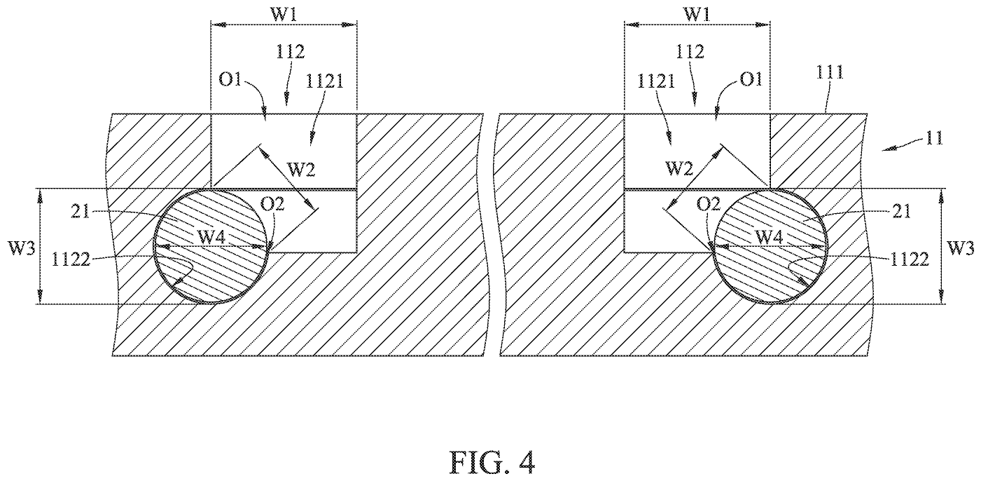

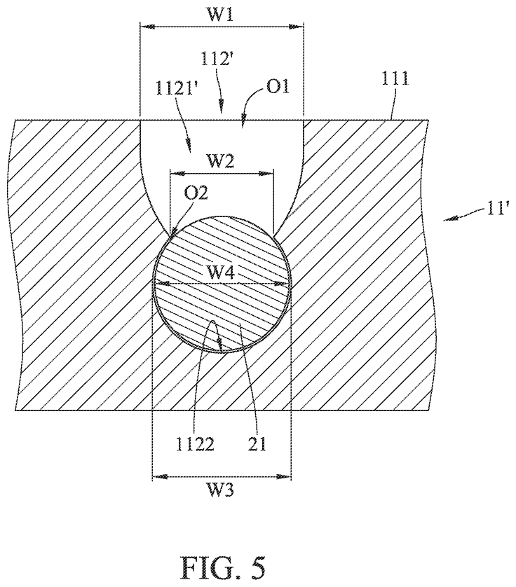

In specific, please further refer to FIG. 4 to focus on the recess 112 of the first layer 11, as shown, the recess 112 may have a slot area 1121 recessed downward from the contact surface 111 and a coil accommodation area 1122 recessed further downward from the bottom corner of the slot area 1121. In other words, the coil accommodation area 1122 is connected to the contact surface 111 via the slot area 1121, and the coil accommodation area 1122 is located at one corner of the slot area 1121 relatively away from the contact surface 11. The coil 21 is allowed to be placed into the coil accommodation area 1122 via the slot area 1121 and therefore to be fixed in the coil accommodation area 1122.

In this embodiment, the slot area 1121 has a first opening O1 at the contact surface 111 (that is, the contact surface 111 has a first opening O1 to expose the slot area 1121), the slot area 1121 has a second opening O2 directly connected to the coil accommodation area 1122 (that is, the slot area 1121 and the coil accommodation area 1122 have a second opening O2 inbetween), the slot area 1121 may have a cross-section in a quadrilateral shape, the coil accommodation area 1122 may have a cross-section in round shape. Herein, the first opening O1 has a first width of W1, the second opening O2 has a second width of W2, the cross-section of the coil accommodation area 1122 may have a third width of W3, and the coil 21 has a fourth width of W4 (i.e., the diameter of the cross-section of the coil 21).

The above widths satisfy the following conditions: W1≥W2, W3>W2. Optionally, the above widths may further satisfy one of the following conditions: W1>W3, W1≈W3, and W1<W3. In addition, in one embodiment, W3 may be substantially the same as W4, that is, W3≈W4.

In detail, the space defined by the coil accommodation area 1122 has a shape and size substantially matching and fitting the coil 21, that is, W3 may be slightly larger than, smaller than, or substantially the same as W4. This ensures that the inner surface of the coil accommodation area 1122 is able to cover and contact the surface of the coil 21 to firmly secure the coil 21 in the coil accommodation area 1122. In the case that the cross-sections of both the coil accommodation area 1122 and the coil 21 are in round shape, W3 and W4 may indicate the diameter of the respective cross-section. In the case that the cross-section of the coil accommodation area is not in a round shape (e.g., polygonal shape or oval shape), the third width means the maximum width of the cross-section defined by the coil accommodation area.

The configuration that the first width W1 is larger than the third width W3 facilitates the placement of the coil 21 into the slot area 1121 through the first opening O1. In other embodiments, the first width W1 may be substantially equal to or smaller than the third width W3, the flexibility of the first layer 11 still allows the coil 21 to be put into the slot area 1121 via the first opening O1.

The configuration that the second width W2 is at least smaller than the third width W3 limits the surface of the coil 21 that is exposed from the accommodation area 1122, ensuring that the inner surface of the coil accommodation area 1122 can firmly hold the coil 21 in position and can prevent the coil 21 from coming out of the coil accommodation area 1122 due to external force.

The sizes of the first opening O1 and the second opening O2 not only can facilitate the placement of the coil 21 but also can improve the yield rate of the recess 112. In detail, to manufacture a first layer 11 with a recess 112, an injection mold corresponding to the required shape of the recess 112 is needed, during the manufacturing process of the first layer 11 using the injection mold, high heat and pressure are involved to inject molten material inside the mold, thus the sizes of the first opening O1 and the second opening O2 have to ensure that the portion of the mold for forming the slot area 1121 has a sufficient thickness to sustain the high pressure without breaking. In other words, the portion of the mold for forming the area between the coil accommodation area 1122 and the contact surface 111 shall have a certain thickness, otherwise it may be broken or deformed by high pressure during injection process. According to experimental results, when the first opening O1 is larger than the second opening O2 (i.e., the first width W1 is larger than or equal to the second width W2), the slot area 1121 will have a width that ensures the portion of the mold for forming the slot area 1121 to have a thickness sufficient to withstand the high pressure without deformation or breaking.

When the second width W2 is too small, the portion of the mold for forming the second opening O2 may have a thickness insufficient to withstand the high pressure. When the second width W2 is too large, the coil accommodation area 1122 may be unable to firmly hold the coil 21 therewithin. To avoid these problems, the second width W2 is needed to be smaller than the fourth width W4 and may be set to be a value that exposes 1/4 of the circumference of the cross-section of the coil 21, i.e., W2≈√2×(W4/2). In the case of W3≈W4, W2≈°2×(W3/2).

Further, to prevent the coil 21 from coming out of the coil accommodation area 1122 when the first layer 11 is deformed or experiencing external force, the coil accommodation area 1122 in different portions of the first layer 11 may be arranged at different sides of the recess 112. As shown in FIG. 4, the coil accommodation area 1122 at the left side of the drawing may be arranged at the bottom left corner of the slot area 1121 while the coil accommodation area 1122 at the right side of the drawing may be arranged at the bottom right corner of the slot area 1121. This arrangement provides restriction in different directions to different portions of the coil 21 so as to help prevent the coil 21 from coming out of the coil accommodation area 1122 due to deformation of the first layer 11 or external force.

As discussed, the coil 21 may be firmly positioned in the first layer 11 by the coil accommodation area 1122, thus there is no need to additional provide adhesive for covering and fixing the coil 21, thereby saving the cost of adhesive and relevant process. In such a case, the slot area 1121 of the recess 112 may remain empty and is absent of any adhesive or solid or liquid substance. But it is noted that the slot area may be filled with adhesive if there is no need to consider the cost. Meanwhile, the slot area 1121 has a certain width to avoid the portion of the mold for forming the slot area 1121 from breaking.

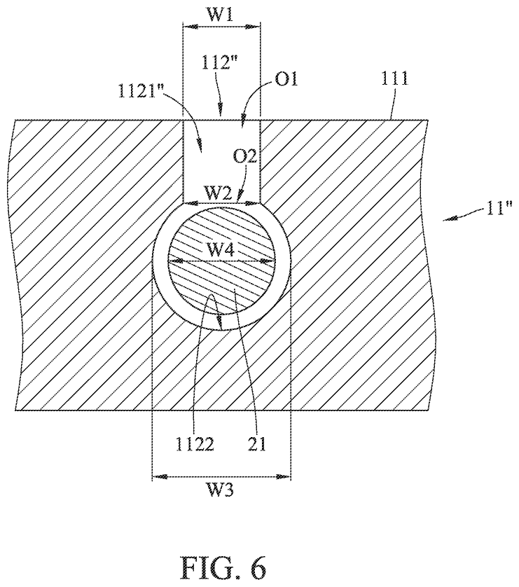

Note that the slot area of the recess may be in any other shape as required as long as the conditions of W1≥W2 and W3>W2 are satisfied. For example, referring to FIG. 5, to avoid repeat illustration, only the differences between a first layer 11′ and the first layer 11 will be described in detail below. In the first layer 11′, the coil accommodation area 1122 may be arranged right under a slot area 1121′ while the conditions of W1≥W2 and W3>W2 are satisfied. In such a configuration, the coil 21 still can be firmly positioned without involving additional adhesive, and the slot area 1121′ still has a width ensuring that the portion of the mold for forming the slot area 1121′ will not be broken due to high pressure.

For example, referring to FIG. 6, to avoid repeat illustration, only the differences between a first layer 11″ and the first layer 11 will be described in detail below. In a recess 112″ of the first layer 11″, as long as that the second width W2 of the second opening O2 of a slot area 1121″ can firmly hold the coil 21 in the coil accommodation area 1122 and is sufficient to prevent the mold from breaking, the first width W1 may be substantially equal to the second width W2.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A wireless charging pad, comprising:
a mat part, comprising:
a first layer, having a contact surface and a recess formed on the contact surface, wherein the recess has a slot area and a coil accommodation area connected to each other, and the coil accommodation area is located at a side of the slot area away from the contact surface; and
a second layer, stacked on the contact surface to cover the recess; and
a coil, located within the coil accommodation area;
wherein the slot area has a first opening at the contact surface, the first opening has a first width of W1, the slot area has a second opening connected to the coil accommodation area, the second opening has a second width of W2, the coil accommodation area has a third width of W3, the following conditions are satisfied:
W1≥W2; and
W3>W2.

2. The wireless charging pad according to claim 1, wherein the coil accommodation area is located at a corner of the slot area relatively away from the contact surface.

3. The wireless charging pad according to claim 1, wherein an inner surface of the coil accommodation area covers the coil.

4. The wireless charging pad according to claim 1, wherein the coil accommodation area in different portions of the first layer is arranged at different corners of the slot area relatively away from the contact surface.

5. The wireless charging pad according to claim 1, wherein the coil has a fourth width of W4, the second opening has the second width of W2, the following condition is satisfied:
W2≈√2×(W4/2).

6. The wireless charging pad according to claim 1, wherein the slot area is hollow.

7. The wireless charging pad according to claim 1, wherein the first layer is made of silicone.

8. The wireless charging pad according to claim 1, further comprising a connection module electrically connected to the coil.
